(19) United States
(12) Patent Application Publication
(10) Pub. No.: US 2026/0252954 A1
(43) Pub. Date: Aug. 27, 2026

(54) METHOD AND ELECTRONIC DEVICE FOR LEARNING MODEL

(71) Applicant: Sionic AI Inc., Seoul (KR)

(72) Inventors: Dokyoon YOON, Seoul (KR); Woomyoung PARK, Seoul (KR)

(21) Appl. No.: 19/260,775

(22) Filed: Jul. 7, 2025

(30) Foreign Application Priority Data
Feb. 21, 2025 (KR) 10-2025-0022640

(51) Int. Cl. G06N 20/00

(52) U.S. Cl. CPC G06N 20/00

(57) ABSTRACT

A method for training a model performed by at least one processor, includes acquiring input data, generating response data for the input data based on a machine learning model, acquiring feedback on the response data, generating a training dataset based on the feedback, and training the machine learning model using the training dataset, wherein the training dataset includes true response data, false response data, and position information indicating a portion of the response data targeted for training.

### CROSS-REFERENCE TO RELATED APPLICATION

This application claims priority to Korean Patent Application No. 10-2025-0022640, filed in the Korean Intellectual Property Office on February 21, 2025, the entire contents of which are hereby incorporated by reference.

### BACKGROUND

### Field

The present disclosure relates to a method for training a model and to an electronic device.

### Description of Related Art

Recently, in the field of natural-language processing, techniques have been developed for optimizing model performance to meet a user’s requirements by using a large language model (LLM) as a base model. As LLMs have come to process multi-modality data, a variety of training tasks for extracting specific information from data in various formats have also been required.

In a model such as an LLM, the model may be modified by reflecting a user’s feedback on responses generated on the basis of the model. However, conventional feedback from the user on a response merely includes an evaluation of the response—for example, a positive or negative evaluation such as “correct”/“incorrect” or “preferred”/“not preferred”—and therefore it has been unavoidable to train on the entirety of the text provided as the response. In that case, a vast amount of training data and computational resources are required, and the model may overfit or incur errors by learning unnecessary portions, and it may be difficult to train the model so that it is suitable for functions desired by the user. Accordingly, there is a demand for development of a technique that generates a training dataset suitable for target learning on the basis of feedback on a response and that trains the model by using the generated training dataset.

### SUMMARY

The present disclosure provides a method for training a model and an electronic device that solve the above-described problems.

The present disclosure may be implemented in various forms, including a method, an apparatus (system), and/or a non-transitory computer-readable storage medium storing computer-readable instructions.

In some embodiments, a method for training a model performed by at least one processor, may include acquiring input data, generating response data for the input data based on a machine learning model, acquiring feedback on the response data, generating a training dataset based on the feedback, and training the machine learning model using the training dataset, wherein the training dataset may include true response data, false response data, and position information indicating a portion of the response data targeted for training.

In some embodiments, generating the training dataset may include setting the response data as the false response data if the feedback includes data indicating negativity, generating the true response data by correcting an erroneous portion of the response data based on a language model, and acquiring the position information based on a position of the erroneous portion.

In some embodiments, generating the training dataset may include setting the response data as the true response data if the feedback includes data indicating positivity, generating the false response data by modifying a portion of the response data, and acquiring the position information based on a position of the modified portion.

In some embodiments, generating the training dataset may include setting corrected data as the true response data if the feedback includes data correcting an erroneous portion of the response data, setting the response data as the false response data, and acquiring the position information based on a position of the erroneous portion.

In some embodiments, the position information may include a predetermined token inserted to indicate the portion targeted for training within the true response data and the false response data.

In some embodiments, the position information may include a masking vector having the same dimension as the response data and configured with an element value corresponding to the portion targeted for training different from element values of other portions.

In some embodiments, training the machine learning model may include constraining parameters involved in portions other than the portion targeted for training among parameters of the machine learning model from being updated.

In some embodiments, a non-transitory computer-readable storage medium storing computer-readable instructions that, when executed by at least one processor, cause the at least one processor to acquire input data, generate response data for the input data based on a machine learning model, acquire feedback on the response data, generate a training dataset based on the feedback, and train the machine learning model using the training dataset, wherein the training dataset may include true response data, false response data, and position information indicating a portion of the response data targeted for training.

In some embodiments, an electronic device may include a memory, and at least one processor connected to the memory and configured to execute computer-readable instructions stored in the memory, wherein the at least one processor is configured to acquire input data, generate response data for the input data based on a machine learning model, acquire feedback on the response data, generate a training dataset based on the feedback, and train the machine learning model using the training dataset, wherein the training dataset may include true response data, false response data, and position information indicating a portion of the response data targeted for training.

In some embodiments, the at least one processor is configured to set the response data as the false response data if the feedback includes data indicating negativity, generate the true response data by correcting an erroneous portion of the response data based on a language model, and acquire the position information based on a position of the erroneous portion.

In some embodiments, the at least one processor is configured to set the response data as the true response data if the feedback includes data indicating positivity, generate the false response data by modifying a portion of the response data, and acquire the position information based on a position of the modified portion.

In some embodiments, the at least one processor is configured to set corrected data as the true response data if the feedback includes data correcting an erroneous portion of the response data, set the response data as the false response data, and acquire the position information based on a position of the erroneous portion.

In some embodiments, the at least one processor is configured to constrain parameters involved in portions other than the portion targeted for training among parameters of the machine learning model from being updated.

According to some embodiments of the present disclosure, by generating a training dataset suitable for target learning on the basis of feedback on a response and training the model by using the generated training dataset, overfitting and errors of the model may be prevented, and the model may be trained so as to be optimized for functions desired by the user.

The effects of the present disclosure are not limited to those mentioned above, and other effects not mentioned will be clearly understood by those of ordinary skill in the art from the description of the claims.

### BRIEF DESCRIPTION OF THE DRAWINGS

Embodiments of the present disclosure will be described below with reference to the accompanying drawings, wherein like reference numerals denote like elements, but the disclosure is not limited thereto.

FIG. 1 exemplarily illustrates an electronic device for training a model according to an embodiment of the present disclosure.

FIG. 2 is a schematic diagram illustrating a configuration in which, in relation to training a model according to an embodiment of the present disclosure, an information-processing system is connected so as to communicate with a plurality of user terminals.

FIG. 3 is a block diagram illustrating internal configurations of a user terminal and an information-processing system according to an embodiment of the present disclosure.

FIG. 4 is a diagram for explaining a configuration of an electronic device for training a model according to an embodiment of the present disclosure.

FIG. 5 is a diagram for explaining a target-learning method according to an embodiment of the present disclosure.

FIG. 6 is a diagram for explaining a method of acquiring user feedback according to an embodiment of the present disclosure.

FIG. 7 is a diagram for explaining another method of acquiring user feedback according to an embodiment of the present disclosure.

FIG. 8 is a diagram for explaining a method for training a model according to an embodiment of the present disclosure.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Accordingly, the terms used in this disclosure should be defined based on the meaning of the term and the overall content of the present disclosure, rather than simply the name of the term.

As used herein, the singular forms "a," "an," and "the" are intended to include the plural forms as well, unless the context clearly indicates the singular forms. Further, the plural forms are intended to include the singular forms as well, unless the context clearly indicates the plural forms. Further, throughout the description, when a portion is stated as "comprising (including)" a component, it is intended as meaning that the portion may additionally comprise (or include or have) another component, rather than excluding the same, unless specified to the contrary.

Further, the term "module" or "unit" used herein refers to a software or hardware component, and "module" or "unit" performs certain roles. However, the meaning of the "module" or "unit" is not limited to software or hardware. The "module" or "unit" may be configured to be in an addressable storage medium or configured to play one or more processors. Accordingly, as an example, the "module" or "unit" may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the "modules" or "units" may be combined into a smaller number of components and "modules" or "units", or further divided into additional components and "modules" or "units."

A "module" or "unit" may be implemented as a processor and a memory, or may be implemented as a circuit (circuitry). Terms such as circuit and circuitry may refer to circuits in hardware, but may also refer to circuits in software. The "processor" should be interpreted broadly to encompass a general-purpose processor, a central processing unit (CPU), a microprocessor, a digital signal processor (DSP), a neural processing unit (NPU), a controller, a microcontroller, a state machine, etc. Under some circumstances, the "processor" may refer to an application-specific integrated circuit (ASIC), a programmable logic device (PLD), a field-programmable gate array (FPGA), etc. The "processor" may refer to a combination for processing devices, e.g., a combination of a DSP and a microprocessor, a combination of a plurality of microprocessors, a combination of one or more microprocessors in conjunction with a DSP core, or any other combination of such configurations. In addition, the "memory" should be interpreted broadly to encompass any electronic component that is capable of storing electronic information. The "memory" may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is said to be in electronic communication with a processor if the processor can read information from and/or write information to the memory. The memory integrated with the processor is in electronic communication with the processor.

In addition, terms such as first, second, A, B, (a), (b), etc. used in the following examples are only used to distinguish certain components from other components, and the nature, sequence, order, etc. of the components are not limited by the terms.

In addition, in the following examples, if a certain component is stated as being “connected," “combined” or “coupled” to another component, it is to be understood that there may be yet another intervening component “connected," “combined” or “coupled” between the two components, although the two components may also be directly connected or coupled to each other.

In addition, as used in the following examples, “comprise” and/or “comprising” does not foreclose the presence or addition of one or more other elements, steps, operations, and/or devices in addition to the recited elements, steps, operations, or devices.

Hereinafter, various examples of the present disclosure will be described in detail with reference to the accompanying drawings.

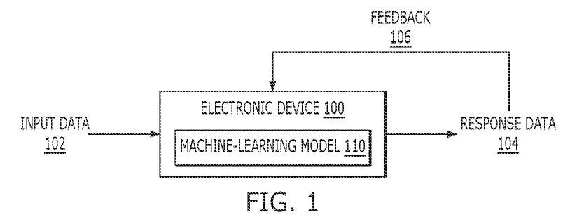

FIG. 1 illustrates, by way of example, an electronic device 100 for training a model according to an embodiment of the present disclosure. Referring to FIG. 1, the electronic device 100 for training a model may train a machine-learning model 110 on the basis of feedback 106 on response data 104. The machine-learning model 110 may include a language model (for example, an LLM) or a multi-modal model. A multi-modal model may be an artificial neural-network model that processes and learns various types of data (for example, image data, text data, audio data, and video data) simultaneously, grasps interactions or context among the data, and thereby generates an output.

The electronic device 100 may include a display, a memory, and at least one processor. However, the configuration of the electronic device 100 is not limited thereto. According to various embodiments, the electronic device 100 may further include at least one other component in addition to the above-described components. For example, the electronic device 100 may further include a communication circuit (or communication module) for communication with an external electronic device.

The display may visually provide information. For example, the display may present various content (for example, text, images, audio, video, icons, and/or symbols) to the user. In an example, the display may present input data 102 and response data 104 for the input data 102. In another example, the display may provide a user interface for receiving feedback 106 on the response data 104.

According to an embodiment, the display may include a touch screen and may receive a touch, a gesture, a proximity input, or a hovering input made by an electronic pen or part of the user’s body. The display may include a touch sensor configured to detect a touch or a pressure sensor configured to measure a force generated by the touch, and may include a sensor circuit or a control circuit for controlling the sensor.

The memory may store various data used by at least one component (for example, the processor) of the electronic device 100. The data may include, for example, software (or programs) and input or output data related thereto. The memory may include volatile memory or nonvolatile memory.

The processor may be connected to the display and the memory and configured to execute at least one computer-readable program included in the memory. For example, by executing software (or programs), the processor may control at least one other component (for example, hardware or software components) of the electronic device 100 connected to the processor and may perform various data-processing or arithmetic operations. According to an embodiment, as at least part of data-processing or arithmetic operations, the processor may load commands or data received from another component (for example, the communication circuit) into the volatile memory, process the commands or data stored in the volatile memory, and store result data in the nonvolatile memory.

At least one program executed by the processor may include instructions related to training a model. In the following description, it is described that the processor performs certain functions, but for convenience of explanation, these functions may be understood as being performed when the processor executes instructions included in at least one program stored in the memory.

The processor may acquire input data 102. The processor may then generate response data 104 for the input data 102 on the basis of the machine-learning model 110. For example, the processor may acquire a natural-language query from the user and generate a response to the natural-language query on the basis of an LLM.

The processor may then acquire feedback 106 on the response data 104. The feedback 106 may include data indicating a positive or negative evaluation, such as “correct”/“incorrect” or “preferred”/“not preferred,” of the response data 104. Alternatively, the feedback 106 may include data in which an erroneous portion (or a portion not preferred) of the response data 104 is corrected. For example, by directly correcting an erroneous portion (or a portion not preferred) of the response data 104, the user may provide the feedback 106 on the response data 104. To acquire such feedback 106 from the user, the processor may provide a user interface. For example, through a touch-screen display, the processor may present an object corresponding to the response data 104 and receive a signal corresponding to the feedback 106 on the response data 104 from the user.

The processor may then generate a training dataset on the basis of the feedback 106. For example, the processor may generate a training dataset useful for target learning of the machine-learning model 110 on the basis of the feedback 106. Target learning may refer to training the model mainly on local data required for generation of an output, by clearly indicating data targeted for learning and preventing learning from occurring for other data. For example, in the present disclosure, target learning may mean training such that only parameters involved in an erroneous portion (or a portion not preferred) of the response data 104 among parameters of the machine-learning model 110 are updated. The training dataset may include true response data, false response data, and position information indicating a portion of the response data 104 targeted for training. The true response data, that is, ground-truth data, may be output data to be induced for generation for input data when the machine-learning model 110 is trained. The false response data, that is, false data (or hallucination data), may be output data to be suppressed for generation for input data when the machine-learning model 110 is trained.

According to an embodiment, when the feedback 106 includes data indicating negativity, the processor may set the response data 104 as the false response data. The processor may also generate the true response data by correcting an erroneous portion of the response data 104 on the basis of a language model (for example, an LLM). The processor may further acquire the position information indicating a portion targeted for learning on the basis of a position of the erroneous portion of the response data 104. For example, even when the feedback 106 includes only data indicating a negative evaluation, the processor may generate a training dataset suitable for target learning by using a language model.

According to an embodiment, when the feedback 106 includes data indicating positivity, the processor may set the response data 104 as the true response data. The processor may also generate the false response data by hallucinating (or modifying) a portion of the response data 104. The processor may further acquire the position information indicating a portion targeted for learning on the basis of a position of the modified portion of the response data 104. For example, even when the feedback 106 includes only data indicating a positive evaluation, the processor may generate a training dataset suitable for target learning by using a language model. According to an embodiment, the process of generating the false response data by modifying a portion of the response data 104 may be performed by the user or may be performed as a result of computation by a separately trained natural-language-processing model to replace a specific text token.

According to an embodiment, when the feedback 106 includes data in which an erroneous portion of the response data 104 is corrected, the processor may set the corrected data as the true response data. The processor may also set the response data 104 as the false response data. The processor may further acquire the position information indicating a portion targeted for learning on the basis of a position of the erroneous portion of the response data 104. For example, when the user directly corrects an erroneous portion of the response data 104 and thereby provides the feedback 106 on the response data 104, the processor may directly construct the feedback 106 as a training dataset.

According to an embodiment, the position information indicating a portion targeted for learning may include a predetermined token (for example, “[CLS]”) inserted to indicate the portion targeted for learning within the true response data and the false response data. For example, when the response data are “ABCDE” and the portion targeted for learning is “D,” the response data including the position information indicating the portion targeted for learning may be “ABC[CLS]D[CLS]E.”

According to an embodiment, the position information indicating a portion targeted for learning may include a masking vector having the same dimension as the response data 104 and configured such that an element value corresponding to the portion targeted for learning is set differently from element values of other portions. For example, when, as a result of embedding of the response data 104, the size of the embedding vector is L, the masking vector may be a binary vector of size L. Specifically, for example, when the response data are “ABCDE” and the portion targeted for learning is “D,” the sequence length may be five, and the masking vector may be “[0, 0, 0, 1, 0],” in which the value of the fourth element (for example, “1”) is set differently from values of other elements (for example, “0”). That is, the masking vector may be a masking vector that activates only the fourth token.

The processor may then train the machine-learning model 110 by using the generated training dataset. For example, the processor may train the machine-learning model 110 such that only parameters involved in the portion targeted for learning among parameters of the machine-learning model 110 are updated by using the generated training dataset. At that time, the processor may constrain parameters involved in portions other than the portion targeted for learning among parameters of the machine-learning model 110 from being updated by using the generated training dataset.

According to an embodiment, the processor may train the machine-learning model 110 by using a loss function that suppresses generation of false response data for the input data 102 and increases generation of true response data, and the processor may include only a preference for the portion targeted for learning in the loss function and remove (or limit) learning for portions other than the portion targeted for learning. According to an embodiment, by training the machine-learning model 110 using Kullback-Leibler divergence, the processor may cause (or induce) the model not to learn data for which learning is not required.

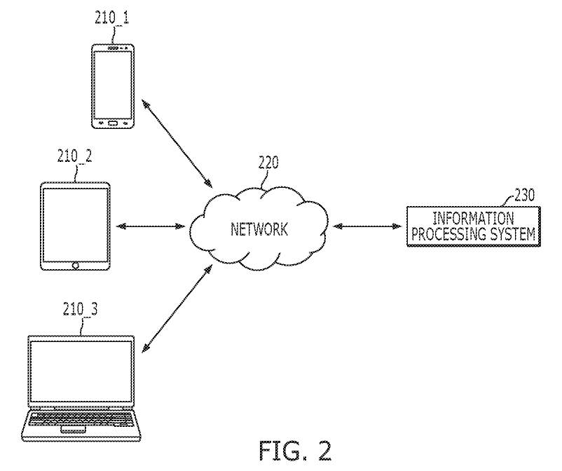

FIG. 2 is a schematic diagram illustrating a configuration in which, in relation to training a model according to an embodiment of the present disclosure, an information-processing system 230 is connected so as to communicate with a plurality of user terminals 210_1, 210_2, 210_3. The information-processing system 230 may include a system or systems capable of providing services related to training a model. In an embodiment, the information-processing system 230 may include one or more server devices and/or databases, or one or more distributed-computing devices and/or distributed databases based on a cloud-computing service, that can store, provide, and execute computer-executable programs (for example, downloadable applications) and data related to training a model. For example, the information-processing system 230 may include separate systems (for example, servers) for training a model.

Services related to training a model provided by the information-processing system 230 may be provided to a user through an application installed on each of the plurality of user terminals 210_1, 210_2, 210_3 or through a web-browser application. Functions of an electronic device for training a model (for example, the electronic device 100 of FIG. 1) described with reference to FIG. 1 may be performed by operation of the user terminals 210_1, 210_2, 210_3, by operation of the information-processing system 230, or by linked operation of the user terminals 210_1, 210_2, 210_3 and the information-processing system 230.

The plurality of user terminals 210_1, 210_2, 210_3 may communicate with the information-processing system 230 through a network 220. The network 220 may be configured to enable communication between the plurality of user terminals 210_1, 210_2, 210_3 and the information-processing system 230. Depending on the installation environment, the network 220 may be composed of a wired network such as Ethernet, a wired home-network (power-line communication), telephone-line communication devices, or RS-serial communication; a wireless network such as a mobile-communication network, a WLAN, Wi-Fi, Bluetooth, or ZigBee; or a combination thereof. Communication methods are not limited, and, in addition to communication methods that use communication networks that the network 220 may include (for example, a mobile-communication network, wired internet, wireless internet, a broadcasting network, or a satellite network), near-field wireless communication between the user terminals 210_1, 210_2, 210_3 may also be included.

For example, the plurality of user terminals 210_1, 210_2, 210_3 may transmit a data-processing request and commands related to a user request for data processing to the information-processing system 230 through the network 220, and the information-processing system 230 may receive them.

In FIG. 2, a mobile-phone terminal 210_1, a tablet terminal 210_2, and a PC terminal 210_3 are depicted as examples of user terminals, but the disclosure is not limited thereto, and the user terminals 210_1, 210_2, 210_3 may be any computing devices capable of wired and/or wireless communication and of running an application. For example, the user terminals may include a smartphone, a mobile phone, a navigation device, a computer, a laptop, a digital-broadcast terminal, a PDA, a PMP, a tablet PC, a game console, a wearable device, an IoT device, a VR device, or an AR device. Although three user terminals 210_1, 210_2, 210_3 are illustrated in FIG. 2 as communicating with the information-processing system 230 through the network 220, the disclosure is not so limited, and different numbers of user terminals may be configured to communicate with the information-processing system 230 through the network 220.

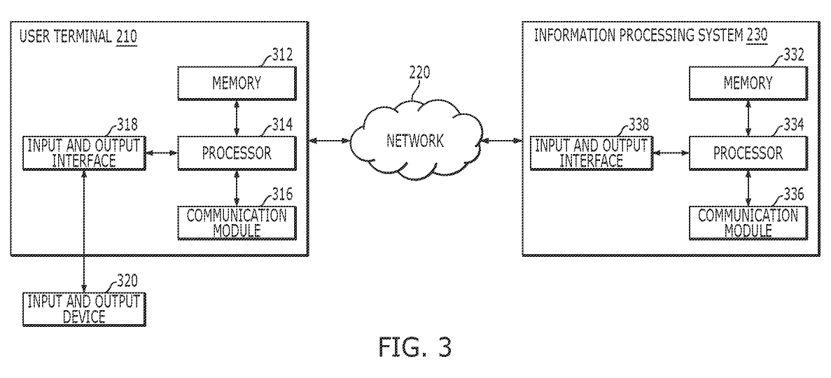

FIG. 3 is a block diagram illustrating internal configurations of a user terminal 210 and the information-processing system 230 according to an embodiment of the present disclosure. The user terminal 210 may denote any computing device capable of running an application and of wired/wireless communication, and may include, for example, the mobile-phone terminal 210_1, the tablet terminal 210_2, or the PC terminal 210_3 of FIG. 2. As illustrated, the user terminal 210 may include a memory 312, a processor 314, a communication module 316, and an input and output interface 318. Similarly, the information-processing system 230 may include a memory 332, a processor 334, a communication module 336, and an input and output interface 338. As shown in FIG. 3, the user terminal 210 and the information-processing system 230 may each be configured to communicate information and/or data through the network 220 by using the respective communication modules 316 and 336. An input and output device 320 may be configured, through the input and output interface 318, to input information and/or data to the user terminal 210 or to output information and/or data generated by the user terminal 210.

The memories 312 and 332 may include any non-transitory computer-readable storage media. According to an embodiment, the memories 312 and 332 may include a permanent mass-storage device such as a ROM, a disk drive, an SSD, or a flash memory. As another example, a permanent mass-storage device such as a ROM, an SSD, a flash memory, or a disk drive may be included in the user terminal 210 or the information-processing system 230 as a separate permanent-storage device distinct from the memory. The memories 312 and 332 may store an operating system and at least one program code (for example, code for an application related to training a model).

These software components may be loaded from a computer-readable storage medium separate from the memories 312 and 332. Such separate computer-readable storage media may include storage media that can be connected directly to the user terminal 210 or the information-processing system 230, for example, a floppy drive, a disk, a tape, a DVD/CD-ROM drive, or a memory card. As another example, the software components may be loaded into the memories 312 and 332 through the communication modules 316 and 336 rather than from a computer-readable storage medium. For example, at least one program may be loaded into the memories 312 and 332 on the basis of a computer program (for example, an application related to training a model) installed by files distributed by a file-distribution system, used by developers or for distributing application installation files, provides installation files through the network 220.

The processors 314 and 334 may be configured to process instructions of computer programs by performing basic arithmetic, logic, and input/output operations. Instructions may be provided to the processors 314 and 334 by the memories 312 and 332 or by the communication modules 316 and 336. For example, the processors 314 and 334 may be configured to execute instructions received according to program code stored in recording devices such as the memories 312 and 332.

The communication modules 316 and 336 may provide functions or configurations for enabling the user terminal 210 and the information-processing system 230 to communicate with each other through the network 220, and may provide functions or configurations for enabling the user terminal 210 and/or the information-processing system 230 to communicate with another user terminal or another system (for example, a separate cloud system). For example, a request or data (for example, a data-processing request or data) generated by the processor 314 of the user terminal 210 according to program code stored in a recording device such as the memory 312 may be delivered to the information-processing system 230 through the network 220 under control of the communication module 316. Conversely, a control signal or command provided under control of the processor 334 of the information-processing system 230 may be received by the user terminal 210 through the communication module 336 and the network 220 and then through the communication module 316 of the user terminal 210.

The input and output interface 318 may be means for interfacing with the input and output device 320. As an example, the input device may include devices such as a camera that includes an audio sensor and/or an image sensor, a keyboard, or a microphone, and the output device may include devices such as a display, a speaker, or a haptic-feedback device. As another example, the input and output interface 318 may be means for interfacing with a device that integrates functions or configurations for input and output in a single device, such as a touch screen. In FIG. 3, the input and output device 320 is illustrated as not being included in the user terminal 210, but the disclosure is not limited thereto, and the user terminal 210 and the device may be configured as a single device. The input and output interface 338 of the information processing system 230 may be means for interfacing with a device (not shown) for input or output that can be connected to or included in the information processing system 230. The input and output interfaces 318 and 338 are illustrated in FIG. 3 as components separate from the processors 314 and 334, but the disclosure is not limited thereto, and the input and output interfaces 318 and 338 may be configured to be included in the processors 314 and 334.

The user terminal 210 and the information-processing system 230 may include more components than those illustrated in FIG. 3. However, it is unnecessary to illustrate most conventional technical components explicitly. In an embodiment, the user terminal 210 may be implemented to include at least some of the above-described input and output devices 320. The user terminal 210 may also further include other components such as a transceiver, a GPS module, a camera, various sensors, or a database. For example, when the user terminal 210 is a smartphone, the user terminal 210 may generally include components included in a smartphone, and various components such as an accelerometer, a gyroscope, a microphone module, a camera module, various physical buttons, buttons using a touch panel, input/output ports, or a vibrator for vibration may be further included in the user terminal 210.

According to an embodiment, the processor 314 of the user terminal 210 may be configured such that an application or a web-browser application that provides services related to training a model is executed. In that case, program code related to the application may be loaded into the memory 312 of the user terminal 210. While the application is executed, the processor 314 of the user terminal 210 may receive information and/or data provided from the input and output device 320 through the input and output interface 318 or receive information and/or data from the information-processing system 230 through the communication module 316, process the received information and/or data, and store the processed information and/or data in the memory 312. Such information and/or data may also be provided to the information-processing system 230 through the communication module 316.

While the application is executed, the processor 314 may receive voice data, text, an image, or a video that is input or selected through an input device, connected to the input and output interface 318, such as a touch screen, a keyboard, a camera including an audio sensor and/or an image sensor, or a microphone, store the received voice data, text, image, and/or video in the memory 312, or provide the same to the information-processing system 230 through the communication module 316 and the network 220. According to an embodiment, the processor 314 may receive user input that is input through the input device, and may provide data or a request corresponding to the received user input to the information-processing system 230 through the network 220 and the communication module 316.

The processor 314 of the user terminal 210 may transmit information and/or data through the input and output interface 318 to the input and output device 320 so as to output the information and/or data. For example, through an output device 320 such as a display-capable device (for example, a touch screen or a display) or a voice-output-capable device (for example, a speaker), the processor 314 of the user terminal 210 may output processed information and/or data.

The processor 334 of the information-processing system 230 may be configured to manage, process, and/or store information and/or data received from a plurality of user terminals 210 and/or a plurality of external systems. Information and/or data processed by the processor 334 may be provided to the user terminal 210 through the communication module 336 and the network 220.

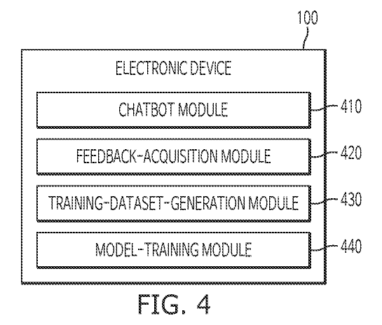

FIG. 4 is a diagram for explaining a configuration of the electronic device 100 for training a model according to an embodiment of the present disclosure. Referring to FIG. 4, the electronic device 100 for training a model may include a chatbot module 410, a feedback-acquisition module 420, a training-dataset-generation module 430, and a model-training module 440. However, the kinds of components included in the electronic device 100 (for example, the chatbot module 410, the feedback-acquisition module 420, the training-dataset-generation module 430, and the model-training module 440) are classified according to functions related to training a model, and the kinds and numbers thereof are not limited thereto. The components included in the electronic device 100 may be implemented by at least one of software elements and hardware elements. For example, at least one of the components included in the electronic device 100 may be implemented in the form of instructions stored in the memory, and the instructions may be executed by the processor.

The chatbot module 410 may process a user’s input (for example, a natural-language query) and generate an appropriate response thereto. For example, the chatbot module 410 may acquire input data and may generate and output response data for the input data. To that end, the chatbot module 410 may provide a user interface. The chatbot module 410 may perform functions of natural-language understanding for analyzing a sentence input by the user and grasping its meaning, dialogue management for managing the flow of the dialogue and tracking an interaction state with the user, and response generation for generating an appropriate response to the user’s question or request.

The feedback-acquisition module 420 may acquire the user’s feedback on the response data. To that end, the feedback-acquisition module 420 may provide a user interface. The user interfaces provided by the chatbot module 410 and the feedback-acquisition module 420 may be the same or different. For example, the chatbot module 410 and the feedback-acquisition module 420 may provide a user interface in cooperation or linkage. Through the user interface, the feedback-acquisition module 420 may acquire data indicating a positive evaluation or a negative evaluation, or may acquire data in which an erroneous portion (or a portion not preferred) of the response data is corrected.

The training-dataset-generation module 430 may generate a training dataset suitable for target learning on the basis of feedback acquired through the feedback-acquisition module 420. The training dataset may include true response data, false response data, and position information indicating a portion of the response data targeted for learning.

According to an embodiment, when feedback acquired through the feedback-acquisition module 420 includes data indicating negativity, the training-dataset-generation module 430 may set the response data as the false response data. The training-dataset-generation module 430 may also generate the true response data by correcting an erroneous portion of the response data on the basis of a language model (for example, an LLM). The training-dataset-generation module 430 may further acquire the position information indicating a portion targeted for learning on the basis of a position of the erroneous portion of the response data.

According to an embodiment, when feedback acquired through the feedback-acquisition module 420 includes data indicating positivity, the training-dataset-generation module 430 may set the response data as the true response data. The training-dataset-generation module 430 may also generate the false response data by hallucinating (or modifying) a portion of the response data. The training-dataset-generation module 430 may further acquire the position information indicating a portion targeted for learning on the basis of a position of the hallucinated (or modified) portion of the response data.

According to an embodiment, when feedback acquired through the feedback-acquisition module 420 includes data in which an erroneous portion of the response data is corrected, the training-dataset-generation module 430 may set the corrected data as the true response data. The training-dataset-generation module 430 may also set the response data as the false response data. The training-dataset-generation module 430 may further acquire the position information indicating a portion targeted for learning on the basis of a position of the erroneous portion of the response data.

The model-training module 440 may train a machine-learning model (for example, the machine-learning model 110 of FIG. 1) by using the generated training dataset. The machine-learning model may include a language model (for example, an LLM) or a multi-modal model. The model-training module 440 may train the machine-learning model such that only parameters involved in the portion targeted for learning among parameters of the machine-learning model are updated by using the generated training dataset. At that time, the model-training module 440 may constrain parameters involved in portions other than the portion targeted for learning among parameters of the machine-learning model from being updated by using the generated training dataset.

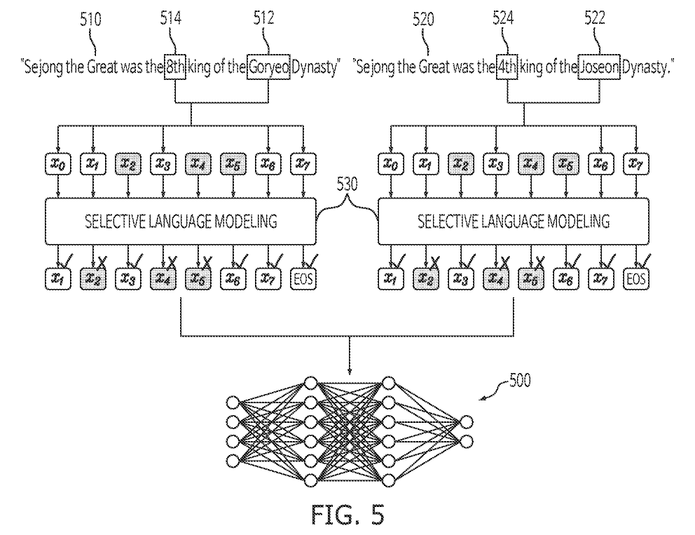

FIG. 5 is a diagram for explaining a target-learning method according to an embodiment of the present disclosure. Referring to FIG. 5, the processor of an electronic device 100 for training a model (for example, the electronic device 100 of FIGS. 1 and 4) may generate a training dataset for target learning. The training dataset may include true response data 520, false response data 510, and position information indicating a portion targeted for learning. For example, when the true response data 520 are “Sejong the Great was the 4th king of the Joseon Dynasty.” and the false response data 510 are “Sejong the Great was the 8th king of the Goryeo Dynasty.”, a position of a token 522 corresponding to “Joseon” in the true response data 520 is the same as a position of a token 512 corresponding to “Goryeo” in the false response data 510, and information on the position may be set as the position information indicating a portion targeted for learning. Similarly, a position of a token 524 corresponding to “4” in the true response data 520 is the same as a position of a token 514 corresponding to “8” in the false response data 510, and information on the position may also be set as the position information indicating a portion targeted for learning.

According to an embodiment, on the basis of selective language modeling 530, the processor may selectively train only specific portions, not the entirety, of the true response data 520 and the false response data 510 in a machine-learning model 500 (for example, the machine-learning model 110 of FIG. 1). For example, through the selective language modeling 530, the processor may exclude portions other than the portions targeted for learning (for example, the token 522 corresponding to “Joseon,” the token 512 corresponding to “Goryeo,” the token 524 corresponding to “4,” and the token 514 corresponding to “8”) from the true response data 520 and the false response data 510. The processor may then exclude portions other than those targeted for learning (for example, the token 522 corresponding to "Joseon" and the token 524 corresponding to "4" from the true response data 520, and the token 512 corresponding to "Goryeo" and the token 514 corresponding to "8" from the false response data 510), compare those targeted for learning, and train the machine-learning model 500. According to an embodiment, by training the machine-learning model 500 using Kullback-Leibler divergence, the processor may induce the model not to learn data for which learning is not required.

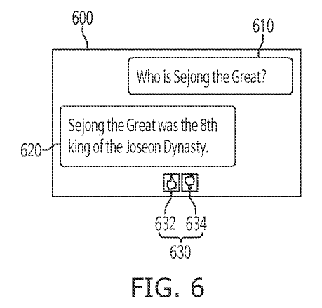

FIG. 6 is a diagram for explaining a method of acquiring user feedback according to an embodiment of the present disclosure. Referring to FIG. 6, through a chatbot system (for example, the chatbot module 410 of FIG. 4), the processor of an electronic device 100 for training a model (for example, the electronic device 100 of FIGS. 1 and 4) may acquire input data, generate response data for the acquired input data, and output the response data. For example, through a user interface 600 provided by the chatbot system, the processor may receive a user input 610 and provide a response 620 for the received input 610.

The processor may then acquire user feedback on the response data. To that end, the processor may output, through the user interface 600, an object 630 requesting the user’s feedback on the response 620 provided by the chatbot system. For example, the processor may display, on the user interface 600, a visual object 632 indicating a positive evaluation and a visual object 634 indicating a negative evaluation. At that time, the processor may arrange the visual object 632 indicating a positive evaluation and the visual object 634 indicating a negative evaluation adjacent to the response 620 provided by the chatbot system.

When the user selects either the visual object 632 indicating a positive evaluation or the visual object 634 indicating a negative evaluation, the processor may generate feedback data corresponding to the selected visual object. For example, in response to reception of a user input selecting the visual object 632 indicating a positive evaluation, the processor may include data indicating positivity in the feedback data. In response to reception of a user input selecting the visual object 634 indicating a negative evaluation, the processor may include data indicating negativity in the feedback data.

The processor may then generate a training dataset on the basis of the feedback data. In an example, when the feedback data include data indicating negativity, the processor may set the response data as the false response data, generate the true response data by correcting an erroneous portion of the response data on the basis of a language model (for example, an LLM), and generate the position information indicating a portion targeted for learning on the basis of a position of the erroneous portion of the response data. In another example, when the feedback data include data indicating positivity, the processor may set the response data as the true response data, generate the false response data by hallucinating (or modifying) a portion of the response data, and generate the position information indicating a portion targeted for learning on the basis of a position of the hallucinated (or modified) portion of the response data.

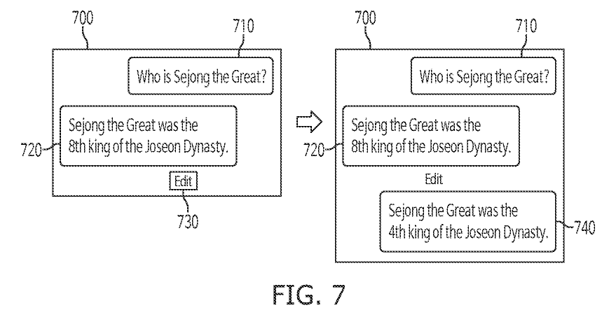

FIG. 7 is a diagram for explaining another method of acquiring user feedback according to an embodiment of the present disclosure. Referring to FIG. 7, through a chatbot system (for example, the chatbot module 410 of FIG. 4), the processor of an electronic device 100 for training a model (for example, the electronic device 100 of FIGS. 1 and 4) may acquire input data, generate response data for the acquired input data, and output the response data. For example, through a user interface 700 provided by the chatbot system, the processor may receive a user input 710 and provide a response 720 for the received input 710.

The processor may then acquire user feedback on the response data. To that end, the processor may output, through the user interface 700, an object 730 requesting the user’s feedback on the response 720 provided by the chatbot system. For example, the processor may display, on the user interface 700, an object 730 (for example, a button object) for hallucinating (or modifying) the response 720 provided by the chatbot system. At that time, the processor may arrange the object 730 for hallucinating (or modifying) the response 720 adjacent to the response 720 provided by the chatbot system.

When the user selects the object 730 for hallucinating (or modifying) the response 720, the processor may provide an object 740 (for example, a text field) that allows the response 720 to be modified. When the user then modifies the response 720 through the object 740 that allows the response 720 to be modified, the processor may generate feedback data as the modified data. For example, by directly correcting an erroneous portion (or a portion not preferred) of the response 720, the user may provide feedback on the response 720.

The processor may then generate a training dataset on the basis of the feedback data. For example, when the feedback data include data in which an erroneous portion of the response data is corrected, the processor may set the corrected data as the true response data, set the response data as the false response data, and generate the position information indicating a portion targeted for learning on the basis of a position of the erroneous portion of the response data.

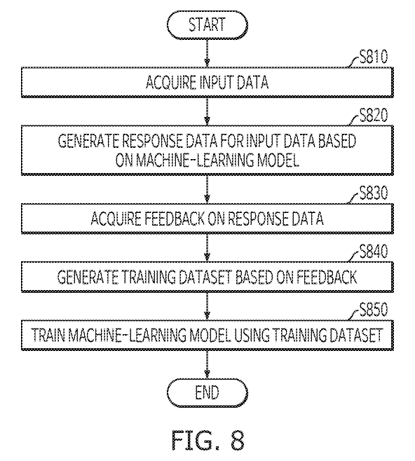

FIG. 8 is a diagram for explaining a method for training a model according to an embodiment of the present disclosure. Referring to FIG. 8, in step S810, the processor of an electronic device 100 for training a model (for example, the electronic device 100 of FIGS. 1 and 4) may acquire input data. For example, through a chatbot system (for example, the chatbot module 410 of FIG. 4), the processor may receive a user’s input (for example, a natural-language query).

In step S820, the processor may generate response data for the input data on the basis of a machine-learning model (for example, the machine-learning model 110 of FIG. 1 or the machine-learning model 500 of FIG. 5). For example, the processor may receive a natural-language query from the user through the chatbot system, generate a response to the natural-language query on the basis of an LLM, and output the generated response through the chatbot system.

In step S830, the processor may acquire feedback on the response data. For example, through a user interface (for example, the chatbot system), the processor may receive user feedback on the response data. The feedback may include data indicating a positive or negative evaluation. The feedback may also include data in which an erroneous portion (or a portion not preferred) of the response data is corrected.

In step S840, the processor may generate a training dataset on the basis of the feedback. For example, the processor may generate a training dataset useful for target learning of the machine-learning model on the basis of the feedback. The training dataset may include true response data, false response data, and position information indicating a portion of the response data targeted for learning. In an example, when the feedback includes data indicating negativity, the processor may set the response data as the false response data, generate the true response data by correcting an erroneous portion of the response data on the basis of a language model (for example, an LLM), and acquire the position information indicating a portion targeted for learning on the basis of a position of the erroneous portion of the response data. In another example, when the feedback includes data indicating positivity, the processor may set the response data as the true response data, generate the false response data by hallucinating (or modifying) a portion of the response data, and acquire the position information indicating a portion targeted for learning on the basis of a position of the modified portion of the response data. In yet another example, when the feedback includes data in which an erroneous portion of the response data is corrected, the processor may set the corrected data as the true response data, set the response data as the false response data, and acquire the position information indicating a portion targeted for learning on the basis of a position of the erroneous portion of the response data.

According to an embodiment, the position information indicating a portion targeted for learning may include a predetermined token (for example, “[CLS]”) inserted to indicate the portion targeted for learning within the true response data and the false response data. According to an embodiment, the position information indicating a portion targeted for learning may include a masking vector having the same dimension as the response data and configured such that an element value corresponding to the portion targeted for learning is set differently from element values of other portions.

In step S850, the processor may train the machine-learning model by using the training dataset. For example, the processor may train the machine-learning model such that only parameters involved in the portion targeted for learning among parameters of the machine-learning model are updated by using the generated training dataset. At that time, the processor may constrain parameters involved in portions other than the portion targeted for learning among parameters of the machine-learning model from being updated by using the generated training dataset.

According to an embodiment, the processor may train the machine-learning model by using a loss function that suppresses generation of false response data for the input data and increases generation of true response data. At that time, the processor may include only a preference for the portion targeted for learning in the loss function and remove (or limit) learning for portions other than the portion targeted for learning. According to an embodiment, by training the machine-learning model using Kullback-Leibler divergence, the processor may induce the model not to learn data for which learning is not required.

The flowchart and description above are merely examples and may be implemented differently in some examples. For example, in some examples, the order of respective steps may be changed, some steps may be repeatedly performed, some steps may be omitted, or some steps may be added.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, etc. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, etc. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transmission of a computer program from one place to another. The storage media may also be any available media that may be accessible to a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessible to a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or apparatus, and storage may be similarly influenced across a plurality of apparatus. Such apparatus may include PCs, network servers, and portable apparatus.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method for training a model performed by an apparatus comprising at least one processor, the method comprising:
acquiring input data;
generating, based on a machine learning model, response data for the input data;
acquiring feedback on the response data;
generating, based on the feedback, a training dataset; and
training the machine learning model using the training dataset,
wherein the training dataset comprises true response data, false response data, and position information indicating a portion of the response data targeted for training.

2. The method as claimed in claim 1, wherein generating the training dataset comprises:
setting, based on the feedback including data indicating negativity, the response data as the false response data;
generating the true response data by correcting an erroneous portion of the response data based on a language model; and
acquiring the position information based on a position of the erroneous portion.

3. The method as claimed in claim 1, wherein generating the training dataset comprises:
setting, based on the feedback including data indicating positivity, the response data as the true response data;
generating the false response data by modifying a portion of the response data; and
acquiring the position information based on a position of the modified portion.

4. The method as claimed in claim 1, wherein generating the training dataset comprises:
setting, based on the feedback including data correcting an erroneous portion of the response data, corrected data as the true response data;
setting the response data as the false response data; and
acquiring the position information based on a position of the erroneous portion.

5. The method as claimed in claim 1, wherein the position information comprises a predetermined token inserted to indicate the portion targeted for training within the true response data and the false response data.

6. The method as claimed in claim 1, wherein the position information comprises a masking vector having a same dimension as the response data and configured with an element value corresponding to the portion targeted for training different from element values of other portions.

7. The method as claimed in claim 1, wherein training the machine learning model comprises:
constraining parameters involved in portions other than the portion targeted for training among parameters of the machine learning model from being updated.

8. A non-transitory computer-readable storage medium storing computer-readable instructions that, when executed by at least one processor, cause an apparatus to:
acquire input data;
generate, based on a machine learning model, response data for the input data;
acquire feedback on the response data;
generate, based on the feedback, a training dataset; and
train the machine learning model using the training dataset,
wherein the training dataset comprises true response data, false response data, and position information indicating a portion of the response data targeted for training.

9. An electronic device comprising:
a memory; and
at least one processor connected to the memory and configured to execute computer-readable instructions stored in the memory,
wherein the at least one processor is configured to execute the computer-readable instructions to cause the electronic device to:
acquire input data;
generate, based on a machine learning model, response data for the input data;
acquire feedback on the response data;
generate, based on the feedback, a training dataset; and
train the machine learning model using the training dataset,
wherein the training dataset comprises true response data, false response data, and position information indicating a portion of the response data targeted for training.

10. The electronic device as claimed in claim 9, wherein the at least one processor is configured to execute the computer-readable instructions to cause the electronic device to:
set, based on the feedback including data indicating negativity, the response data as the false response data;
generate the true response data by correcting an erroneous portion of the response data based on a language model; and
acquire the position information based on a position of the erroneous portion.

11. The electronic device as claimed in claim 9, wherein the at least one processor is configured to execute the computer-readable instructions to cause the electronic device to:
set, based on the feedback including data indicating positivity, the response data as the true response data;
generate the false response data by modifying a portion of the response data; and
acquire the position information based on a position of the modified portion.

12. The electronic device as claimed in claim 9, wherein the at least one processor is configured to execute the computer-readable instructions to cause the electronic device to:
set, based on the feedback including data correcting an erroneous portion of the response data, corrected data as the true response data;
set the response data as the false response data; and
acquire the position information based on a position of the erroneous portion.

13. The electronic device as claimed in claim 9, wherein the position information comprises a predetermined token inserted to indicate the portion targeted for training within the true response data and the false response data.

14. The electronic device as claimed in claim 9, wherein the position information comprises a masking vector having a same dimension as the response data and configured with an element value corresponding to the portion targeted for training different from element values of other portions.

15. The electronic device as claimed in claim 9, wherein the at least one processor is configured to execute the computer-readable instructions to cause the electronic device to constrain parameters involved in portions other than the portion targeted for training among parameters of the machine learning model from being updated.
